(19) United States
(12) Patent Application Publication
(10) Pub. No.: US 2024/0032712 A1
(43) Pub. Date: Feb. 1, 2024

(54) FRAME COVER

(71) Applicant: Erika Mostert, Tijeras, NM (US)

(72) Inventor: Erika Mostert, Tijeras, NM (US)

(21) Appl. No.: 18/228,568

(22) Filed: Jul. 31, 2023

Related U.S. Application Data
(60) Provisional application No. 63/394,056, filed on Aug. 1, 2022.

(51) Int. Cl. A47G 1/06

(52) U.S. Cl. CPC A47G 1/0622; A47G 1/0627

(57) ABSTRACT

A frame cover apparatus for decorating frames. The apparatus comprises a set of edges and faces, a gripping member, and an expansion and compression edge. The apparatus further comprises a plurality of layers and a modular end with an attachment interface. The apparatus attaches to frames, borders, or edges of objects.

### CROSS-REFERENCE TO RELATED APPLICATIONS

This application claims priority to and the benefit of the filing of U.S. Provisional Patent Application No. 63/394,056, entitled “FRAME COVER”, filed on Aug. 1, 2022, and the specification and claims thereof are incorporated herein by reference.

### BACKGROUND OF THE INVENTION

### Field of the Invention (Technical Field)

The present invention relates to an apparatus for covering the frame, border, or edge of an object.

### Related Art

The aesthetic appearance of home furnishings, picture frames, electronics, and appliances are often changed to appeal to a person's personal taste. Events such as holidays, birthdays, and cultural celebrations often require a change to aesthetic appearance. Aesthetic changes may be achieved by applying paint, affixing decorative objects, or modifying the shape or texture of a frame. However, these aesthetic changes may permanently affect the shape, color, or texture of the frame. What is needed is a way to modify the frames of windows, doors, and drawers without having to go through the expense and burden of permanently affecting the shape, color, or texture of the frame.

### BRIEF SUMMARY OF THE INVENTION

The present invention is directed to an apparatus for covering a frame, the apparatus comprising: a rigid main body; the main body comprising an edge, wherein the edge comprises a first side edge, a second side edge, a top edge, and a bottom edge; the main body further comprising a top face and a bottom face; a gripping structure at least partially disposed along said edge of the main body; and the main body in communication with an expansion edge and a compression edge. In another embodiment, the apparatus comprises an upper layer at least partially disposed above the top face of said main body. In another embodiment, the gripping structure further comprises gripping members.

The present invention is also directed to an apparatus for covering a frame, the apparatus comprising: a rigid main body; the main body comprising an edge, wherein the edge comprises a first side edge, a second side edge, a top edge, and a bottom edge; the main body further comprising a top face and a bottom face; a gripping structure at least partially disposed along the edge of the main body; the main body in communication with an expansion edge and a compression edge; the main body further comprising a plurality of layers; the plurality of layers comprising a middle layer, an upper layer, and a bottom layer; the upper layer at least partially disposed above the middle layer; and the bottom layer at least partially disposed below the middle layer. In another embodiment, the bottom layer is disposed along a length of the middle layer and forming a cavity disposed between the middle layer and the bottom layer. In another embodiment, the middle layer further comprises a protrusion. In another embodiment, the protrusion is in communication with the middle layer. In another embodiment, the upper layer further comprises a protrusion. In another embodiment, the main body further comprises a lighting element. In another embodiment, the lighting element is in communication with the middle layer or the top layer. In another embodiment, the apparatus further comprises a wire in communication with the middle layer or the top layer. In another embodiment, the apparatus further comprises a power source. In another embodiment, each layer of the plurality of layers comprises a curved edge.

The present invention is also directed to an apparatus for covering a frame, the apparatus comprising: a rigid main body; the main body comprising an edge, wherein the edge comprises a first side edge, a second side edge, a top edge, and a bottom edge; the main body further comprising a top face and a bottom face, a gripping structure at least partially disposed along the edge of the main body; the main body in communication with an expansion edge and a compression edge; the main body comprising at least one modular end; the at least one modular end comprising an attachment interface; the attachment interface comprising an orifice; and the attachment interface at least partially disposed along the edge of the main body. In another embodiment, the main body further comprises a width-wise module. In another embodiment, the main body further comprises a hybrid attachment interface. In another embodiment, the main body further comprises a hybrid orifice. In another embodiment, the main body further comprises a center fold. In another embodiment, the main body further comprises an attachment member. In another embodiment, the bottom face of said main body further comprises an end orifice.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a drawing showing a frame cover according to an embodiment of the present invention;

FIG. 2 is a drawing showing a modular frame cover according to an embodiment of the present invention;

FIG. 3 is a drawing showing a bottom view of a frame cover comprising an attachment interface according to an embodiment of the present invention;

FIG. 4 is a drawing showing a bottom view of a frame cover comprising a gripping surface according to an embodiment of the present invention;

FIG. 5 is a drawing showing a side view of a frame cover comprising an upper layer according to an embodiment of the present invention;

FIG. 6 is a drawing showing a bottom view of a modular frame cover, an attachment interface and a connector orifice according to an embodiment of the present invention;

FIGS. 7A and 7B are drawings showing a bottom view of a modular frame cover comprising an attachment interface according to embodiments of the present invention;

FIG. 8 is a drawing showing a bottom view of a modular frame cover comprising a bottom layer according to an embodiment of the present invention;

FIGS. 9A and 9B are drawings showing a side view and front view, respectively, of a frame cover comprising an upper, middle, and bottom layer according to embodiments of the present invention;

FIG. 10 is a drawing showing a bottom view of a modular frame cover comprising two half-sections according to an embodiment of the present invention; and

FIG. 11 is a drawing showing a top view of a modular frame cover comprising embedded lighting according to an embodiment of the present invention.

### DETAILED DESCRIPTION OF THE INVENTION

The invention of the present disclosure relates to an apparatus for covering a frame, e.g., a frame cover. The frame cover may comprise: a body, a first side edge, a second side edge, a top edge, a bottom edge, a top face, a bottom face, an attachment interface at least partially disposed along the bottom face, top edge, and/or bottom edge. The apparatus may further comprise a plurality of layers consisting of mixed rigid and flexible materials.

The term “frame” as used herein shall be interpreted to include any border, region, covering, extension, or edge at least partially disposed around a region. Examples of a frame include, but are not limited to, a door frame, a picture frame, a monitor edge, a drawer edge, a cabinet frame, a window frame, a hardcover book edge, an electronics casing, or a combination thereof.

The term “gripping structure” is defined in the specification and drawings as a structure incorporated into and/or attached to a body and/or layer of the frame cover to allow the frame cover to attach to a frame. The gripping structure may include, but is not limited to, an attachment interface, an expansion edge, a compression edge, or a combination thereof.

The term “attachment interface” as used herein shall be interpreted to include a fastener, buckle, hook, Velcro interface, strap, loop, member, swivel hook, adhesive, magnet, or combination thereof that allows the frame cover to attach to a frame or that allows a first module of a frame cover to attach to a second module of the frame cover.

The term “expansion edge” as used herein shall be interpreted to include an edge where force may be applied against the edge by an object to expand it outward.

The term “compression edge” as used herein shall be interpreted to include an edge capable of exerting force onto an object by compression onto the object.

The frame cover may cover the frame, border, and/or edges of an object. The frame cover may be used for decorating, lighting, protection, or concealing, or a combination thereof. The frame cover may be fitted to cover any frame, border, or edge of an object. The frame cover can be used to change the color, appearance, texture, or size of an object depending on the users liking, seasonal changes, holidays, events, and/or parties. The frame cover may comprise a lighting element to provide illumination or decorative lighting.

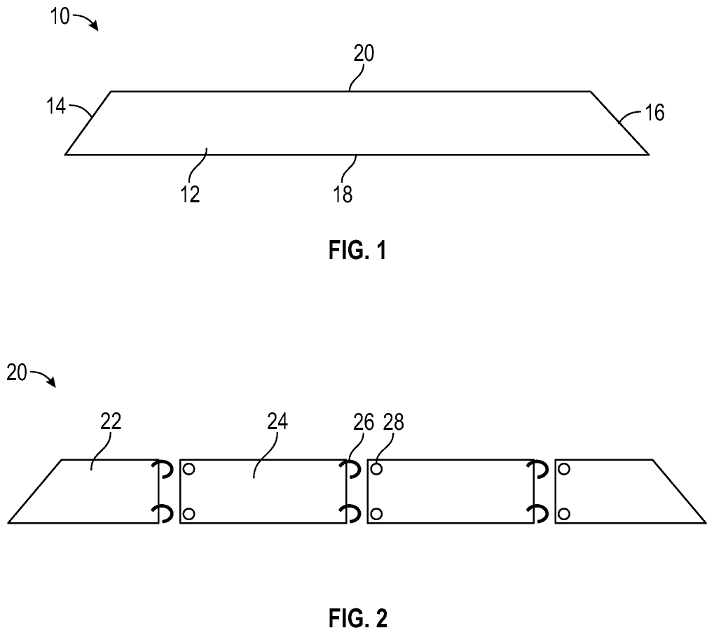

Referring to the figures, FIG. 1 shows frame cover apparatus 10. Frame cover apparatus 10 comprises frame cover body 12, first side edge 14, second side edge 16, bottom edge 18, and top edge 20. Body 12 preferably comprises a polygonal shape. The polygonal shape may include, but is not limited to, a trapezoidal, square, or rectangular shape, or a combination thereof. Body 12 may also comprise a rounded, oval, or bent shape, or a combination thereof.

FIG. 2 shows modular frame cover 20. Modular frame cover 20 comprises at least one modular end 22 and at least one modular body 24. Modular end 22 and/or modular body 24 comprise end attachment interface 26 and/or end orifice 28.

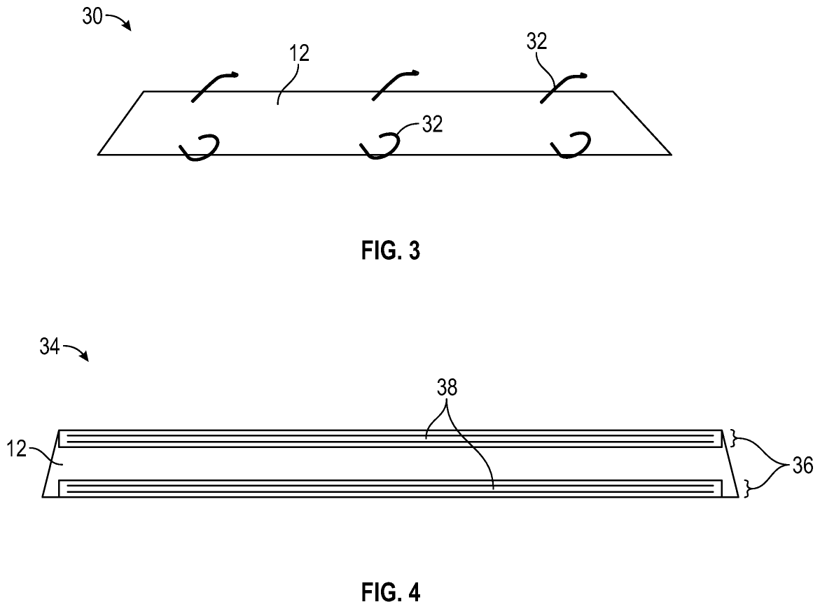

FIG. 3 shows a bottom view of frame cover 30. Attachment interfaces 32 are disposed along the top and bottom edges of frame cover body 12.

FIG. 4 shows a bottom view of frame cover 34. Frame cover 34 comprises frame cover body 12. Gripping structure 36 is disposed along the length of frame cover body 12. Gripping structure 36 comprises gripping members 38. The width of frame cover body 12 is less than the frame to which frame cover 34 is attached. Frame cover 34 comprises an expansion edge and/or a compression edge. Frame cover 34 comprising an expansion edge is attached to a frame by being at least partially disposed over a frame, thereby causing the frame to push against the expansion edge, push the expansion edge outward, and create a pressure on the frame cover 34 that secures it in place. Frame cover 34 comprising a compression edge is attached to a frame by being at least partially disposed over a frame, thereby causing the compression edge to push onto the frame and hold frame cover 34 in place.

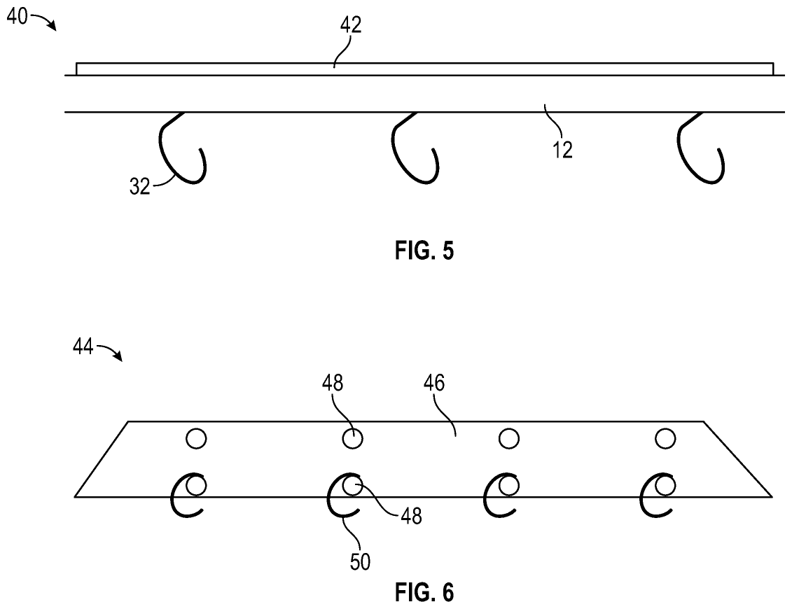

FIG. 5 shows a side view of frame cover 40. Frame cover 40 comprises upper layer 42 at least partially disposed above a top face of frame cover body 12. Attachment interface 32 is at least partially disposed along a bottom face of frame cover body 12.

FIG. 6 shows a bottom view of modular frame cover 44. Modular frame cover 44 comprises modular body 46, hybrid attachment interface 50, and hybrid orifice 48. Hybrid attachment interface 50 and hybrid orifice 48 allow modular frame cover 44 to attach to a second modular body and/or a frame. Modular frame cover 44 is attached to a second modular body at any of its edges, e.g., the side edges, bottom edge, and/or top edge of modular body 46.

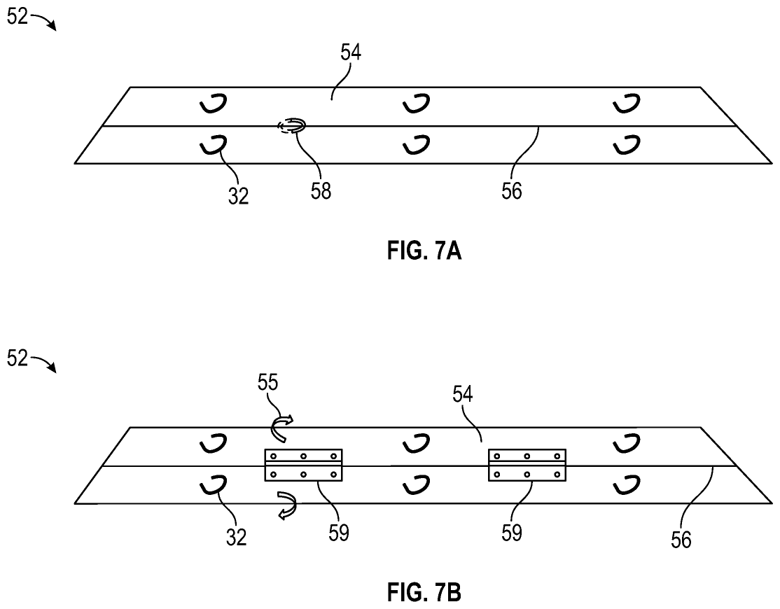

FIGS. 7A and 7B show a bottom view of modular frame cover 52. Modular frame cover 52 is collapsible and/or bendable and comprises center fold 56 and length-wise modular body 54, and attachment interface 32. Modular frame cover 52 comprises a plurality of modular bodies 54. One or more modular bodies 54 are attached by attachment member 58. Attachment member 58 may include, but is not limited to, a hook, hinge, ring, buckler, or a combination thereof. As shown in FIG. 7B, hinge 59 allows modular frame cover 52 to collapse inward according to path 55. Hinge 59 may be disposed vertically, horizontally, or diagonally along modular frame cover 52.

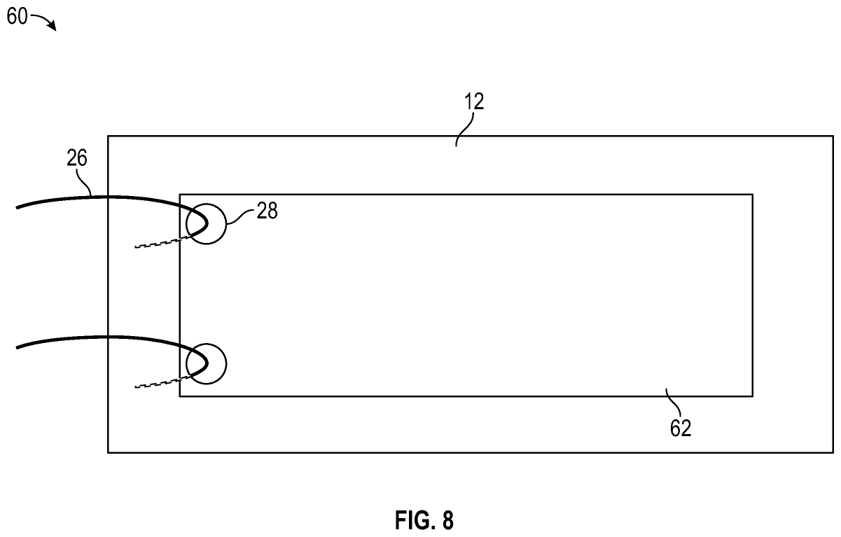

FIG. 8 shows a bottom view of modular frame cover 60. Modular frame cover 60 comprises bottom layer 62 at least partially disposed beneath and/or attached to frame cover body 12. Bottom layer 62 comprises end orifice 28 for receiving and/or interfacing with end attachment interface 26.

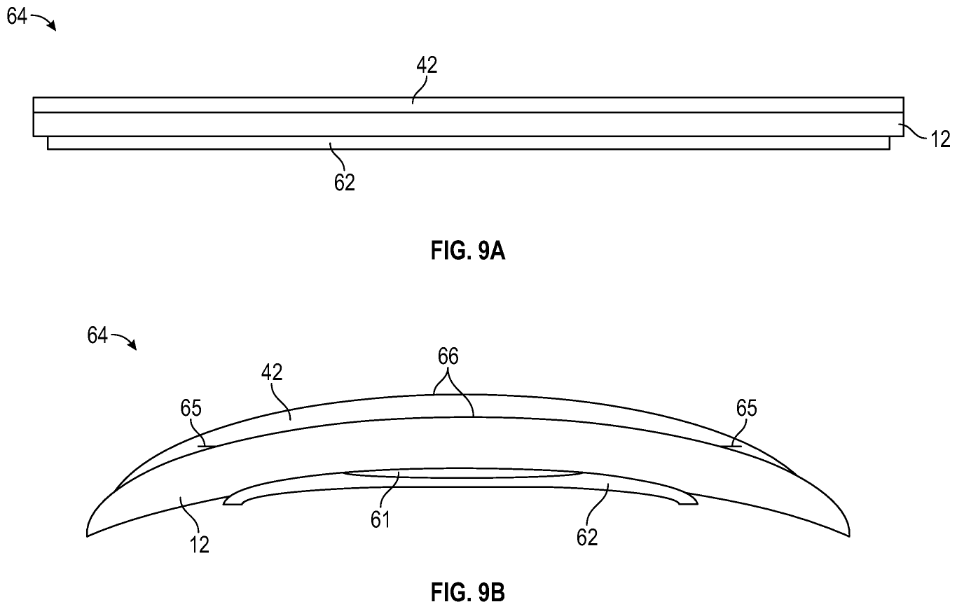

FIGS. 9A and 9B show side and front views, respectively, of frame cover 64. Frame cover 64 comprises frame cover body and/or middle layer 12, upper layer 42 at least partially disposed above frame cover body and/or middle layer 12, and bottom layer 62 at least partially disposed below frame cover body and/or middle layer 12. Frame cover body and/or middle layer 12 comprises protrusion 65 for attaching upper layer 42. Upper layer 42 and frame cover body and/or middle layer 12 comprises curved edges 66. Bottom layer 62 and frame cover body and/or middle layer 12 form cavity 61.

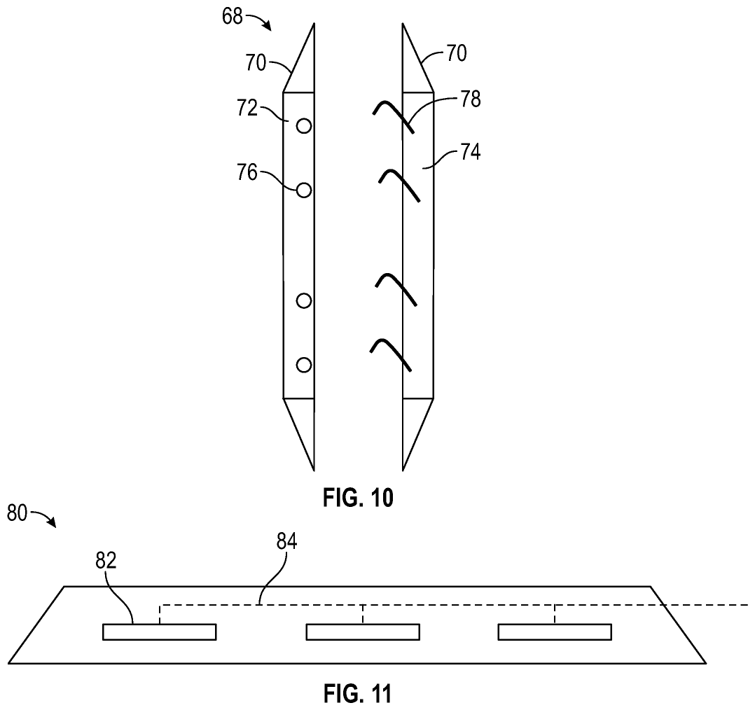

FIG. 10 shows a bottom view of modular frame cover 68. Modular frame cover 68 comprises modular end 70 that may be attached to and/or unattached from length-wise modular body 72 or length-wise modular body 74. Lengthwise modular body 72 comprises one or more length-wise attachment orifices 76. Length-wise modular body 74 comprises one or more length-wise attachment interfaces 78.

FIG. 11 shows a bottom view of modular frame cover 80. Modular frame cover 80 comprising one or more lighting elements 82 connected by wire 84.

The frame cover may comprise of a plurality of layers. The plurality of layers preferably comprises an upper, middle, and bottom layer. The middle layer may comprise a gripping structure, attachment interface, a body, a top face, and a bottom face. Optionally, the middle layer may comprise a hinge, groove and/or protrusion to allow attachment of the upper layer to the middle layer. The hinge may be disposed vertically, horizontally, or diagonally on and/or within the middle layer. The middle layer may comprise any color, pattern, texturing, element, or combination thereof.

The upper layer may comprise a body, a top face, and a bottom face. The upper layer may be disposed above and/or be attached to the middle layer. Optionally, the upper layer may comprise a groove and/or protrusion and be attached to the middle layer by fitting the groove over the protrusion of the middle layer. The top layer may comprise any color, pattern, texturing, element, or combination thereof. The upper layer may comprise a material with a higher elasticity and/or flexibility compared to a material of the middle layer.

The bottom layer may comprise a body, a top face, and a bottom face. The bottom layer may be disposed along and attached to the length of the middle layer and may form a cavity disposed between the middle layer and bottom layer. The bottom layer may comprise a material with a higher elasticity and/or flexibility compared to a material of the middle layer and may comprise a narrower width compared to the middle layer.

The frame cover may comprise a gripping structure. The gripping structure may be disposed along the length and/or width of the frame cover and/or middle layer, upper layer, and/or bottom layer of the frame cover. The gripping structure may also be disposed along the first side edge, second side edge, top edge, bottom edge, or a combination thereof of the frame cover and/or middle layer, upper layer, and/or bottom layer of the frame cover.

The frame cover may comprise a plurality of sections forming a collapsible body. The collapsible body may be bent and/or folded along its midline. A hinge may be disposed along the length of the collapsible body to collapse, fold, close, and/or open the frame cover. The hinge may be disposed horizontally, vertically, or diagonally on the collapsible body.

The frame cover may comprise a rigid and/or flexible material. The material may include, but is not limited to, rubber, silicone, wood, plastic, ceramic, metal, fabric, felt, foam, glass, bone, or a combination thereof.

The frame cover may comprise at least one color and/or pattern. The pattern may include, but it not limited to, a dot, a stripe, a stippling, a swirl, a checker, a geometric design and/or shape, or a combination thereof. The frame cover may further comprise a textured surface. The textured surface may comprise a groove, a grain, a dimple, a bump, a protrusion, or a combination thereof.

The frame cover may comprise a lighting element. The lighting element may comprise a light-emitting diode (“LED”), a fluorescent material and/or light, a reflective material, a light bulb, a conductive filament, or a combination thereof. The lighting element may be at least partially disposed above or within a frame cover. The lighting element may also be at least partially disposed above or within the middle and/or top layers of a frame cover. The frame cover and/or top and middle layers of the frame cover may comprise a plurality of lighting elements. The lighting element or LED may be removed, upgraded, or replaced with a different lighting element or LED. The lighting element may further be left empty as a compartment. The frame cover may further comprise a wire at least partially disposed above or within the middle and/or top layers of a frame cover. The wire may connect one or more lighting elements. The frame cover may be in communication with a power source. The power source may comprise a battery, electrical outlet, solar cell, or a combination thereof. The frame cover may further comprise a battery. The battery may be disposed in the cavity between the middle layer and bottom layer of the frame cover.

The frame cover may be modular. The frame cover may comprise a plurality of length-wise modules to allow modulation of the frame cover's length. Each length-wise frame cover module may comprise a separate color, pattern, lighting element, and/or texture. The frame cover may comprise any number of length-wise modules. Each length-wise module may comprise a gripping structure to allow attachment to a frame; an attachment interface; and a first side edge and a second side edge. An attachment interface may be disposed at the first side edge and/or second side edge. The attachment interface may be used to attach a first length-wise module to a second length-wise module.

The frame cover may be modular. The frame cover may comprise a plurality of width-wise modules to allow modulation of the frame cover's width. Each width-wise frame cover module may comprise a separate color, pattern, lighting element, and/or texture. The frame cover may comprise any number of width-wise modules. Each width-wise module may comprise a gripping structure to allow attachment to a frame; an attachment interface; and a bottom edge and a top edge. An attachment interface may be disposed at the top edge and/or bottom edge. The attachment interface may be used to attach a first width-wise module to a second width-wise module.

Note that in the specification and claims, “about” or “approximately” means within twenty percent (20%) of the numerical amount cited. The terms, “a”, “an”, “the”, and “said” mean “one or more” unless context explicitly dictates otherwise.

Although the invention has been described in detail with particular reference to these embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

Embodiments of the present invention can include every combination of features that are disclosed herein independently from each other. Unless specifically stated as being “essential” above, none of the various components or the interrelationship thereof are essential to the operation of the invention. Rather, desirable results can be achieved by substituting various components and/or reconfiguration of their relationships with one another.

What is claimed is:

1. An apparatus for covering a frame comprising:
a rigid main body;
said main body comprising an edge, wherein said edge comprises a first side edge, a second side edge, a top edge, and a bottom edge;
said main body further comprising a top face and a bottom face;
a gripping structure at least partially disposed along said edge of said main body; and
said main body in communication with an expansion edge and a compression edge.

2. The apparatus of claim 1 further comprising an upper layer at least partially disposed above the top face of said main body.

3. The apparatus of claim 1 wherein said gripping structure further comprises gripping members.

4. An apparatus for covering a frame comprising:
a rigid main body;
said main body comprising an edge, wherein said edge comprises a first side edge, a second side edge, a top edge, and a bottom edge;
said main body further comprising a top face and a bottom face;
a gripping structure at least partially disposed along said edge of said main body;
said main body in communication with an expansion edge and a compression edge;
said main body further comprising a plurality of layers;
said plurality of layers comprising a middle layer, an upper layer, and a bottom layer;
said upper layer at least partially disposed above said middle layer; and
said bottom layer at least partially disposed below said middle layer.

5. The apparatus of claim 4 wherein said bottom layer is disposed along a length of said middle layer and forming a cavity disposed between said middle layer and said bottom layer.

6. The apparatus of claim 4 wherein said middle layer further comprises a protrusion.

7. The apparatus of claim 6 wherein said protrusion is in communication with said middle layer.

8. The apparatus of claim 4 wherein said upper layer further comprises a protrusion.

9. The apparatus of claim 4 wherein said main body further comprises a lighting element.

10. The apparatus of claim 9 wherein said lighting element is in communication with said middle layer or said top layer.

11. The apparatus of claim 9 further comprising a wire in communication with said middle layer or said top layer.

12. The apparatus of claim 9 wherein said lighting element further comprises a light-emitting diode (“LED”).

13. The apparatus of claim 4 further comprising a power source.

14. The apparatus of claim 4 wherein each layer of said plurality of layers comprise a curved edge.

15. An apparatus for covering a frame comprising:
a rigid main body;
said main body comprising an edge, wherein said edge comprises a first side edge, a second side edge, a top edge, and a bottom edge;
said main body further comprising a top face and a bottom face;
a gripping structure at least partially disposed along said edge of said main body;
said main body in communication with an expansion edge and a compression edge;
said main body comprising at least one modular end;
said at least one modular end comprising an attachment interface;
said attachment interface comprising an orifice; and
said attachment interface at least partially disposed of along said edge of said main body.

16. The apparatus of claim 15 wherein said main body further comprises a width-wise module.

17. The apparatus of claim 15 wherein said main body further comprises a hybrid attachment interface.

18. The apparatus of claim 15 wherein said main body further comprises a hybrid orifice.

19. The apparatus of claim 15 wherein said main body further comprises a center fold.

20. The apparatus of claim 15 wherein said main body further comprises an attachment member.
